(19) United States
(12) Patent Application Publication
(10) Pub. No.: US 2002/0012482 A1
(43) Pub. Date: Jan. 31, 2002

(54) Bearings

(76) Inventor: David Kenneth Pridgeon, Rotherham (GB)

Correspondence Address: MADSON & METCALF, GATEWAY TOWER WEST, SUITE 900, 15 WEST SOUTH TEMPLE, SALT LAKE CITY, UT, 84101

(21) Appl. No.: 09/954,901

(22) Filed: Sep. 18, 2001

Related U.S. Application Data
(63) Continuation of application No. 09/142,650, filed on Apr. 12, 1999, now abandoned.

(30) Foreign Application Priority Data
Mar. 12, 1996 (GB) 9605221.2

(51) Int. Cl. F16C 41/00

(52) U.S. Cl. 384/36

(57) ABSTRACT

The present invention provides a bearing system, particularly suited to bridges and other civil engineering applications, which more readily stands hostile environments over extended periods. The bearing system includes one or more contact surfaces (34) in which the contact surface is formed from a fiber reinforced material. The use of fabric reinforced thermosetting resins is preferred. The contact surface (34) may additionally be provided with a series of recesses (5) filled with lubricating material.

This invention concerns improvements in and relating to bearings and in particular, though not exclusively bearings for bridge structures and other civil engineering applications.

Many civil engineering applications call for the provision of a bearing surface of a suitable type to allow movement between different elements of the construction. In particular in bridges, the expansion and contraction of the bridge due to temperature changes over a daily and annual cycle calls for substantial movement tolerance is to be allowed between the deck and supports and the foundations for instance. If this movement were not permitted then potential damage could be done to the structure.

Bearing surfaces in bridges are known in the prior art and these commonly provide an element consisting of a low friction material, such as PTFE, on one element and an opposing bearing surface on the other element of highly polished stainless steel.

These prior art systems face a substantial number of disadvantages which have dogged them throughout their use in this field. Despite this, the general design and type of materials employed in these bridge bearings have remained substantially unchanged for 40 years.

The disadvantages faced by the systems are many fold. In particular, the soft nature of the PTFE material means that contamination by dirt/grit embeds into the surface and negates the low friction capability of PTFE. The system must also be provided in a strong and resilient metal mounting to maintain the PTFE in the desired configuration. Unfortunately the materials in themselves also face problems from the environments in which they were used. Bridges by their very nature come into contact with significant quantities of water and salt. The environment is thus corrosive and potentially damaging in other ways to the system. Various mechanical means for attempting to isolate the bearing surface from the environment have been employed, largely without much success.

The present invention aims to provide an easier to manufacture, cheaper, more compact, lower frictional stick/slip and more environmentally tolerant bearing system.

According to a first aspect of the invention we provide a bearing system comprising a first element and second element in sliding contact with one another and wherein one of the elements is provided with a contact surface formed from a fibre reinforced material.

The material is preferably a resin and most preferably a thermosetting resin.

It is particularly advantageous and preferable that the contact surface portion of the second element is also formed of a fibre reinforced thermosetting resin. The contact surface of the second element may be of PTFE or other low friction, preferably polymeric material. Low friction materials include ultra high molecular weight polyethylene, oil filled nylons, PTFE filled thermoplastics and MOS₂ filled thermoplastics. Alternatively a stainless steel contact surface may be provided as one contact surface in a pair.

The whole or substantially the whole of the first and/or second element may be formed of such a fibre reinforced material, most preferably as a laminate.

The bearing system is most preferably a bridge bearing system. The bearing system may be between two or more telescoping elements. The telescoping elements may form the arm or a part of the arm of a lifting assembly, such as a forklift vehicle. Preferably a bearing system adapted to withstand a force of greater than 20N/mm² and more preferably 30N/mm² or even 38N/mm² of contact surface area is provided.

Preferably the fibre reinforcement is in the form of a fabric. The fibres may be of organic or man made material. The fibres may be provided in a size range of between 0.3 mm and 0.5 mm. Preferably the resin matrix material is phenol based or other thermosetting base. The laminate material may also be provided with one or more lubricant fillers, preferably in solid form. Molybdenum disulphide, PTFE or graphite may be used for this purpose.

Preferably the contact surfaces on the first and second element are of complementary form.

The contact surfaces may be planar. A readily available sliding contact may be provided in this way. Planar contact surfaces may be employed in contacts between upright and deck elements and/or between two deck elements in a bridge and/or between deck elements and structures adjoining a bridge, including their use in expansion joints. One of the contact surfaces may comprise stainless steel, for instance a stainless steel sheet. The sheet may be riveted to the body of the element, which may be of laminated material.

The contact surfaces may be defined by complementary recessed and domed surfaces on the respective elements. The concave recess and/or convex dome may be provided as part of a larger element, preferably of the same material. The sliding contact may arise as a result of arcing and/or of rotation of one or both elements relative to one another.

The bearing system may provide both a pair of planar contact surfaces and a pair of complimentary non-planar surfaces, for instance domed and recessed surfaces. One or both of the contact surface pairs may be provide with one or both contact surfaces of fibre reinforced material. Preferably a planar contact surface is provided on an opposing surface of an element to a domed or recessed contact surface. Preferably the element providing both surfaces is formed solely or substantially of the fibre reinforced material. The element providing both surfaces may comprise a planar block from which a domed contact surface depends. The planar block may be of greater extent than the domed surface.

In a particularly preferred form the bearing system comprises an element with a dished contact surface, the dished surface being complimentary to a domed contact surface on an intermediate element, the intermediate element providing a planar contact surface complimentary to a contact surface on a further element. The further element may comprise a contact surface of stainless steel.

Preferably the planar surface of the intermediate element opposes the domed surface of the intermediate element. The planar surface may be a latitudinal plane or parallel to a latitudinal plane of the domed surface.

Releasable fastenings for the first and/or second and/or further element may be provided to facilitate installation and replacement. The fasteners may be accommodated within the boundaries of the contacting surfaces by means of a recess. Alternatively or additionally the fastening means may be provided at locations around the periphery of the contacting surfaces. Again suitable recesses may be provided.

One or both or all three elements may be provided with one or more recesses in the contacting surface or surfaces. The recesses are preferably provided with, and most preferably filled with, a lubricating material. PTFE, petroleum based binder or a combination of both may be provided within the recesses.

Preferably the recesses are provided at a density of more than 2% and most preferably more than 4% of the contact surface. The recesses may be between 1 mm and 5 mm in diameter and most preferably around 3 mm. Suitable depths for the recess range between 1 mm and 5 mm with 3 mm being preferred.

According to a second aspect of the invention we provide the use of a bearing system according to the first aspect of the invention in a bridge structure.

Preferably the bearing surfaces are provided at one or more of the bridge deck to support strut contacts and/or the support structure to foundation contact and/or expansion joints.

Preferably planar contact surface bearing systems are employed at the strut to deck contact and/or deck to deck contact. Preferably rotation tolerant bearing surfaces, ie the dished type, are provided at the support to foundation contact.

A bearing system including an element providing both a planar and a dished or domed contact surface is envisaged.

According to a second aspect of the invention we provide the use of a bearing system according to the first aspect of the invention between telescoping elements.

Preferably two or more bearing systems are provided between two elements telescopically provided relative to one another.

Preferably one or more of the bearing systems provide a dished and domed contact surface pair and a planar contact surface pair. Most preferably one of the dished or domed contact surface and one of the planar contact surfaces are provided by a single member.

According to a fourth aspect of the invention we provide a method of producing a bridge bearing system comprising the steps of:

a) providing a fibre reinforcing;

b) substantially enclosing and/or impregnating the fibre with a material; and

c) producing a bearing surface of the desired configuration from the fibre reinforced material.

The bearing surface may be planar or non-planar as desired depending upon the application for the system. Production of a dished bearing surface offers one preferred format. Preferably a corresponding domed portion is produced from a further portion of laminate material. A plurality of bearing/contact surfaces may be formed on a single element. The method may provide for forming a dished or domed contact surface and a planar contact surface on a single element. Preferably the two contact surfaces are formed on opposing faces of the element.

A resin and most preferably a thermosetting resin is preferred for the material.

The corresponding surface may be formed of PTFE or other, preferably low friction, polymeric material.

The method may also further include the steps of:

providing recesses in the bearing surface, most preferably by drilling, and

introducing a lubricant to the recess.

Most preferably this additional step comprises filling the recesses beyond the bearing surface followed by a machining stage to remove excess lubricant material back to the bearing surface. Most preferably the recesses are filled with the lubricant.

The introduction of PTFE as a heavily loaded suspension in binders, such as petroleum based binder, is particularly preferred. Loadings of PTFE of between 75% and 95% are suited for this purpose.

According to a fifth aspect of the invention we provide the use of a fibre reinforced materials, most preferably thermosetting resin, in bridge bearings.

Preferably both elements of the bearing system are formed from such material.

The use of other features according to the invention may also be provided in each of the various aspects.

An explanation of the prior art, together with a description of various embodiments of the invention will now be provided, by way of example only, and with reference to the accompanying drawings in which:

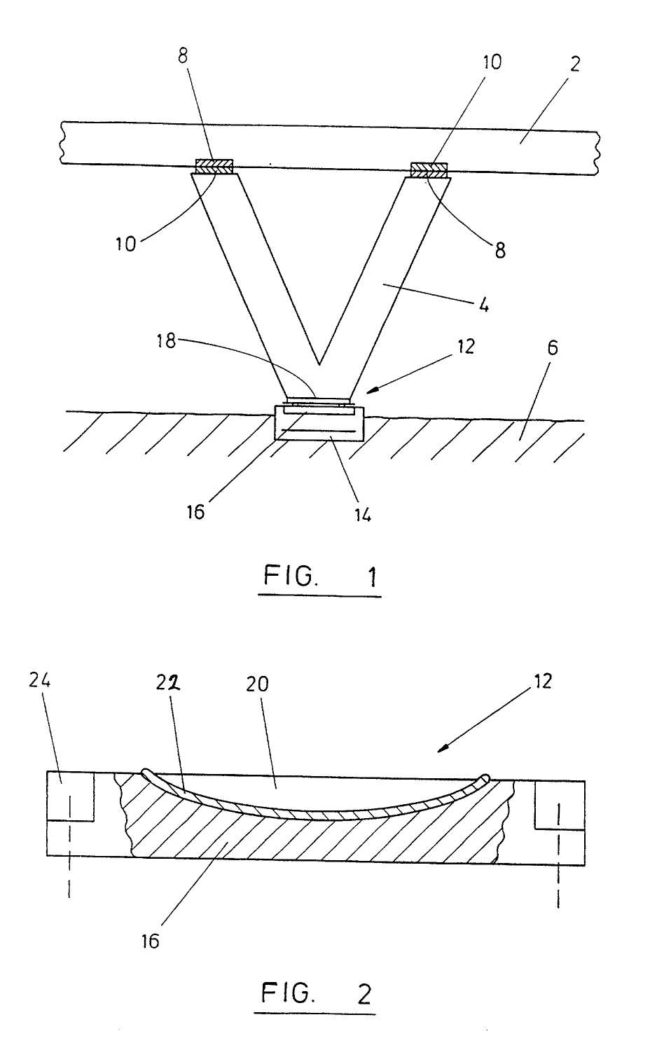

FIG. 1 schematically illustrates a bridge featuring bridge bearings;

FIG. 2 illustrates a partial cross section of a prior art bridge bearing;

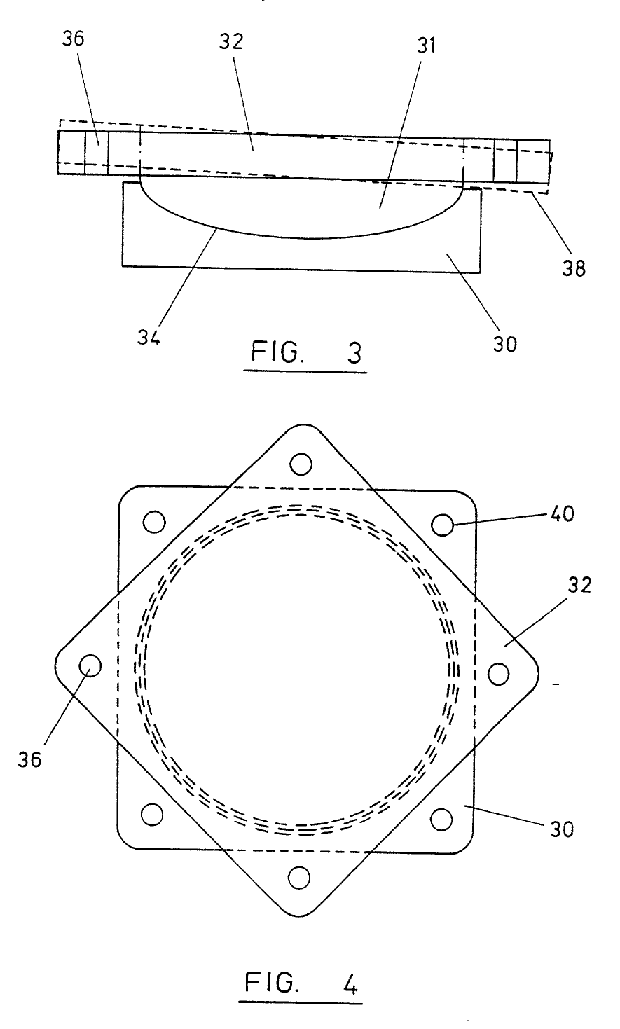

FIG. 3 illustrates a bridge bearing according to a first embodiment of the invention in side view;

FIG. 4 illustrates the bridge bearing of FIG. 3 in plan;

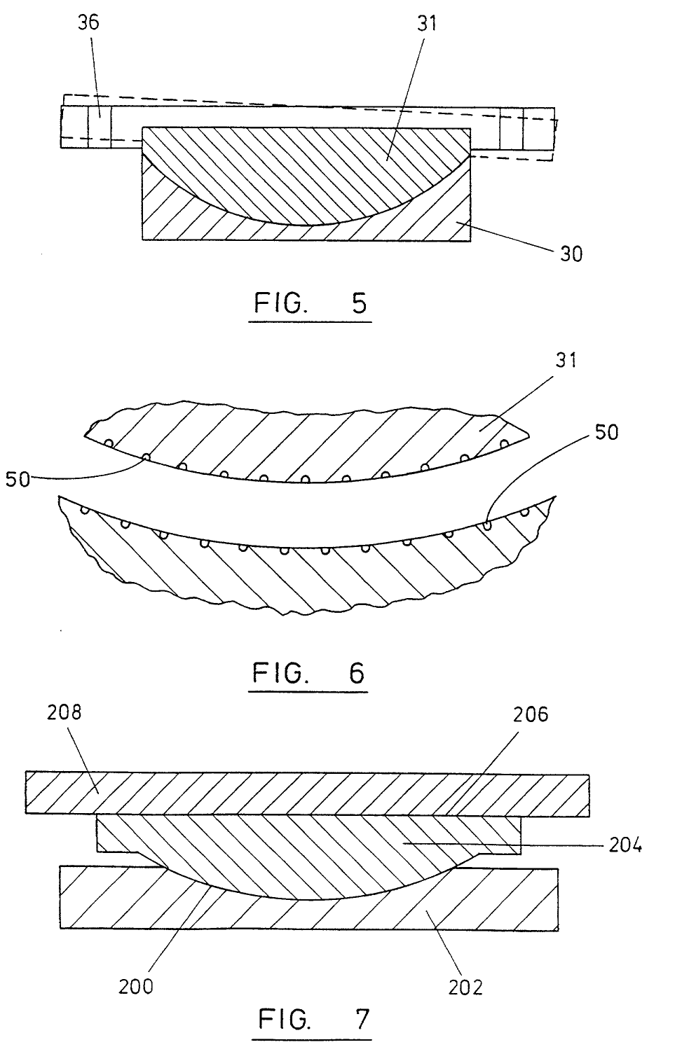

FIG. 5 illustrates a second embodiment of the bridge bearing of the invention;

FIG. 6 schematically illustrates a portion of the bridge bearing according to a further embodiment of the invention;

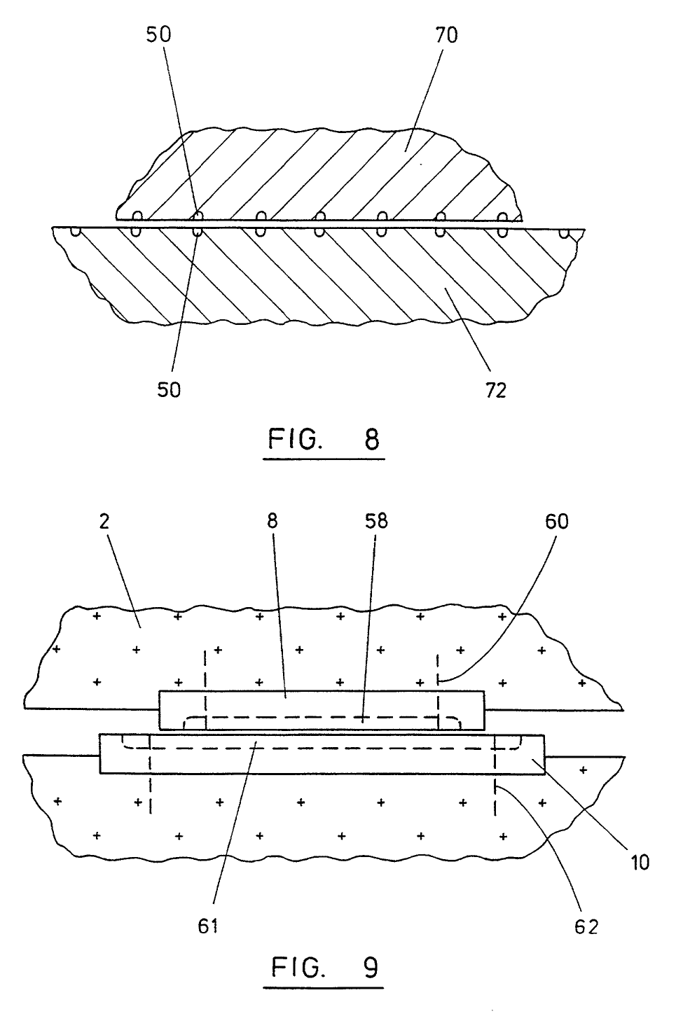

FIG. 7 illustrates a further bearing system according to the invention;

FIG. 8 illustrates another form of prior art bridge bearing;

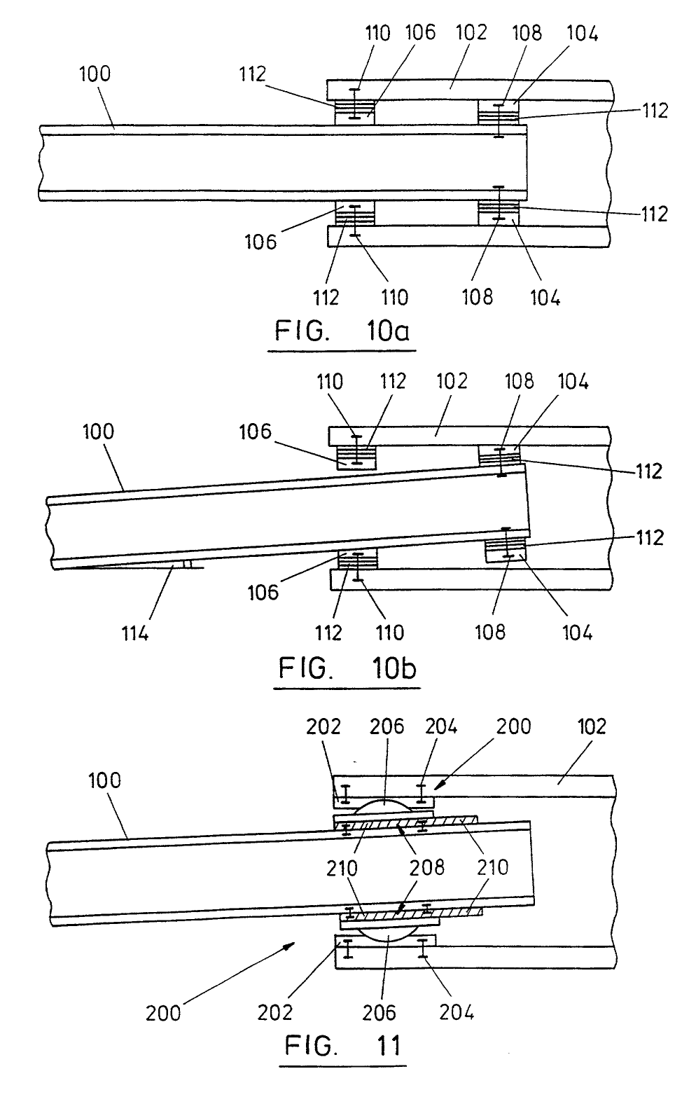

FIG. 9 illustrates a partial cross sectional view of a further embodiment of the invention;

FIG. 10a illustrates a prior art system for telescoping element bearings;

FIG. 10b illustrates schematically problems with the system of FIG. 10a; and

FIG. 11 illustrates the present invention's use in the application of FIGS. 10a and 10b.

Civil engineering structures, in particular bridges, undergo substantial movement during their life. Unless the relative movement of various components within the bridge is allowed for stresses and strains will build up which are potentially damaging. As a consequence, as illustrated in FIG. 1 the contacts between the bridge deck (2) supports (4) and ground (6) are normally provided with bearing surfaces to allow movement.

Bearing surfaces normally come in two types. At the deck (2) to support (4) contact sliding movement is provided for. The bearing surfaces here are provided by block like components mounted one on the deck (2) and one on the support (4). Movement occurs by one block sliding over the other. Prior art systems commonly employ a highly polished metal surface on one of the deck or support and a suitable low friction material such as PTFE in a solid block on the other. Stainless steel or aluminium can be provided as the bearing element (8) and the PTFE as bearing element (10) or in the opposing orientation.

The bearing surface between the supports (4) and ground (6) is normally of a different type. Here a bearing system (12) is mounted between the supports (4) and foundation (14) which in turn is mounted in the ground (6). The part (16) of the bearing system (12) mounted in the foundation (14) commonly consists of a substantial slab element (16) provided with a concave recess (20). Such bearing systems need to be able to withstand forces of over 38 Newton's/mm².

As illustrated in FIG. 2 the slab element (16) commonly consists of a substantial cast/machined element provided with a recess (20). The recess is lined by a low friction material, PTFE, (22). A substantial thickness up to ¼ inch of PTFE is commonly employed in this layer. The layer is produced by securing the PTFE on to the machined surface.

The slab (16) is provided with corner recesses (24) which accommodate releasable fastenings such as bolts to securely mount the slab to the foundation (14).

The corresponding element (18) of the bearing system (12) mounted on the support (4) comprises a plate element of stainless steel or aluminium provided with a curved surface complimentary to the shape of the recess (20). This stainless steel or aluminium bearing surface engages with the PTFE in the lower element (16) and allows for rotational and angular movement of the support (4) relative to the foundation (14) and ground (6).

Whilst PTFE is a suitable material in friction terms it is a relatively soft material and hence is prone to deformation under the loads subjected by the bridge. As a consequence a substantial thickness of material has to be employed and a cost penalty accompanies this as PTFE is an expensive material to produce and provide on the surface. To provide structural rigidity to the unit the substantial slab of stainless steel is required. Clearly the use of a metal element in what is potentially a very hostile environment chemically has disadvantages of its own. The soft nature of the PTFE material also prohibits the use of an opposing PTFE bearing surface hence the use of a stainless steel hemisphere on the upper element (18). Once again as a metal surface this is prone to disadvantages. The soft nature of the PTFE also necessitates a relatively large bearing element so as to reduce the force per unit area at the bearing surface.

The present invention as illustrated in FIGS. 3 and 4 provides a bearing system, for use in support to ground contacts for instance, but offers greatly superior properties particularly in terms of environment resistance.

The bearing system comprises a slab base element (30) provided with a concave recess which accommodates the dome (31) on the upper element (32). The recess may range between 150 to 1300 mm. The upper and base elements engage each other at contact surfaces (34). Fixing of the upper element to the support (4) is effected by means of bolts passing through apertures (36). The play in the upper element (32) relative to the slab (30) is indicated by the alternative position in dotted outline (38).

Fixing of the slab to the foundations is effected by means of bolts passing through apertures (40). Unlike the prior art systems the material forming the slab (30) and the material forming the upper member and dome (31) contact each other directly.

In the embodiment of FIG. 3 the base member (30) projects beyond the edge of the dome element (31).

FIG. 5 illustrates an alternative embodiment of the invention in which spherical surfaced inserts are used to provide the bearing function. These are located inside a suitable carrier.

The materials employed to produce both the upper and lower elements of the bearing system consist of fabric laminates impregnated by a thermosetting resin and provided with solid lubricant fillers. This material has very low water absorption levels, typically less than 0.1% by weight allowing high tolerances to be used without problem. Particular fabrics employed in the material include cotton and polyester. The reinforcing fabrics are provided at a relatively high level in the material and commonly comprise 50% by weight of the laminate. Ranges of 30% to 65% can be used. The fibres are beneficial at the bearing surface as they promote the retention of a full film of lubricant. Thermosetting resins such as phenolic, polyester and epoxy are suitable for the product. Graphite, PTFE and molybdenum disulphide all represent suitable solid lubricant fillers which can be incorporated into the laminate. If appropriate the solid lubricant fillers can be omitted from the product. The provision of the element in a single material avoids differential thermal expansion problems.

Whilst both surfaces may be formed of the same material many of the advantages of the invention are obtained by providing one of the surfaces of the interface as PTFE or other suitable low friction material.

The laminated material can be dry machined using conventional metal and wood working machinery. Tungsten carbide tipped tooling is recommended for cutting and drilling applications.

The recess and hemisphere surfaces are produced by standard workshop machining.

As illustrates in FIG. 6 the concave and convex surfaces of the unit are ideally provided with a series of recesses which assist in the lubrication of the contact surfaces (34). PTFE as a lubricant enhancing material is employed in this embodiment. The recesses are produced in the finish surface by drilling and the lubricant material is introduced in molten or liquid form so as to fill the recesses. The excess material is them machined away so as to leave a series of discrete locations filled with the lubricant material. The provision of PTFE at a very high loading in a petroleum based binder base is very useful system. PTFE levels of 90% weight per cent in a petroleum based binder are readily provided by suspending the PTFE in a molten petroleum based binder liquid which can then be used to fill the recesses.

In use the PTFE or other lubricant enhancing material provides a film on the contact surface (34) promoting lubrication.

As well as a rotational and arcing bearing surface, as discussed above, a bearing system can be provided in which a sliding movement is also facilitated. The system illustrated in FIG. 7 provides a spherical interface 200 between a dished member 202 and a hemispherical member 204 of the type discussed above. In addition, however, this system allows a separate movement of a sliding nature at interface 206 between a linear surface of the hemispherical member 204 and a linear surface on a further member 208.

In this system arcing movement is transferred from the further member 208 through the interface 206 to the hemispherical member 204. The member 204 moves relative to the dished member 200 accommodating the movement at the interface 202.

On the other hand sliding movement is accommodated by the interface 206 with the further member 208, the hemispherical member 204 remaining stationary relative to dished member 200.

As previously discussed the dished, hemispherical and/or further element may be provided of, or with interfaces consisting of fibre laminated resins. Lubricant filled recesses may be provided on one or more contact surfaces in each pair.

FIG. 8 illustrates in more detail the prior art block style sliding contact provided at the bridge deck (2) support (4) contact. The upper block (8) is provided with a central recess (58) which accommodates the heads of releasable fasteners which fasten the block (8) to the deck (2) on axis (60). In a similar manner the lower block (10) on the support (4) is provided with an equivalent recess (61) which again allows fastening of the block to the support (4) along axis (62). In this prior art system the upper or lower block consists of a stainless steel or aluminium element and the other block is provided as solid PTFE. Metal to PTFE contact at the surface is thus always provided.

The present invention on the other hand in this embodiment, illustrated in FIG. 9, provides a pair of blocks (70, 72) which while fastened in a similar way provide significant advantages over the prior art systems. Both the blocks (70, 72) are provided in the laminate style material discussed above. The lubrication of the surface is further assisted by the provision of recesses (50) provided with lubricant enhancing materials as discussed in the context of FIG. 6 above. A superior sliding block system is thus provided when compared with prior art arrangements.

As well as bridge deck structures such blocks can be used to provide bearing surfaces successfully in any application in which one or both members are required to slide relative to one another. Such uses include telescoping booms or arms in which a first member slides in and out of a larger cross-section element.

As illustrated in FIG. 10a telescopic booms generally consist of a first element/arm 100 which is slidably mounted within a larger cross-section element/arm 102. The two elements move relative to one another due to different forces depending on the elements in question. Thus a bridge or other civil engineering structure may move due to thermal expansion. On the other hand the metal box sections forming the lifting arm of a forklift vehicle may be moved due to the arms accompanying hydraulics.

In any event the elements 100,102 are provided with wear pads 104,106 respectively, which are fastened to their respective element by releasable fasteners 108,110 respectively. The tolerances between the steel elements are quite large and shims 112 are provided as a consequence to reduce the gap by packing them under the wear pads 104,106.

In use the force acting through the wear pads varies in magnitude and direction according to the position of the elements 100, 102 relative to one another. None-perpendicular forces result in preferential wear rates for certain pads and certain portions of a given pad. With use, therefore, the wear pads become worn and the thickness of material between the elements 100,102 decreases. The decrease tends to be uneven, however, and this increase the level of play between the elements 100,102 and results in the elements developing an angle 114 relative to one another, FIG. 10b. This reduces the contact area of the pads and still further so increases the rate of wear still further. Regular servicing and re-shimming is necessary to avoid the problem.

The present invention overcomes this problem by providing self-aligning wear pads. Suitable bearing systems for this purpose are illustrated in FIG. 7. The bearing systems incorporate both a pair of planar contact surfaces and pair of non-planar complementary contact surfaces. As illustrated in use in FIG. 11 in two bearing systems 200, a dished element 202 is securely mounted on the element 102 in which element 100 telescopes, by means of releasable fasteners 204. The dished contact surface of this element 202 cooperates with a domed contact surface on an intermediate element 206. On the opposing side of the intermediate element to the domed surface, the intermediate element 206 is provided with a planar contact surface which in turn contacts a further planar contact surface provided on a further element 210 to form interface 208. The further element 210 is firmly attached by releasable fasteners to the telescopic element 100.

In the other pair of bearing systems, not shown, the bearing system is reversed with the further element 210 being releasably fastened to the element 102 and with the dished element 202 being releasably connected to the element 100. The intermediate element 206, with both domed and planar contact surfaces, is provided in the same manner.

In use, this system accommodates both sliding and any angular movement between the elements 100 and 102, or changes in direction in the forces between the two, without loss of contact area between the various contact surfaces. Thus as illustrated in FIG. 11 where the element 100 is angled relative to element 102 the desired sliding movement between the two elements is accommodated by the planar contact surfaces at interface 208 between the intermediate member 206 and the further member 210 whilst the change in angle is accommodated by a rotation of the intermediate member 206 relative to the dished member 202.

In accommodating the movement the contact surface area between the respective members is also maintained at its full, or substantially close to its full value. As a consequence of this full contact area and the ability of the dished and domed contact surfaces to adequately transmit non-perpendicular forces between the elements 100,102, reduced overall wear and the avoidance of preferential wear locations is achieved. The longer active life of the wear pads reduces the frequency with which servicing is required and avoids the need for shims to adjust the clearance.

As discussed above, the applications to which bearing systems of this type are put are frequently hostile environments. Grit, water, salt and other materials potentially hostile to prior art lubricating systems are to be regularly found in the practical applications in which the bearing is employed. Swelling of the plastics material (nylon can absorb 4 to 6% by weight) and corrosion of metal material is frequently encountered in the prior art. As a consequence, prior art systems are prone to damage and deterioration in the face of such hostile materials. On the contrary, the present invention is fully resistant to both salt and water whether individually or in combination. Indeed the presence of water and in particular salt water within the bearing system can have beneficial properties for the present invention as the coefficient friction can actually be reduced. The low swelling, due to absorption being very low, allows tighter clearances to be used restricting the entry of dirt into the bearing surface area. Thus not only are the prior art problems encountered but they unexpectedly assist the present system.

1. A bridge bearing system comprising a first element and a second element in sliding contact with one another and wherein one of the elements is provided with a contact surface formed from a fiber reinforced material comprising a thermosetting resin and fabric fiber laminate.

2. A bridge bearing system according to claim 1 in which the contact surface is provided between the bridge deck and the bridge supports and/or between bridge supports and the ground or bridge foundations.

3. A bridge bearing system according to claim 1 in which the contact surface can withstand a force greater than 20 N/mm².

4. A bridge bearing system according to claim 3 in which the fiber reinforcement is in the form of a fabric and in which the fibers are between 0.3 and 0.5 mm in diameter.

5. A bridge bearing system according to claim 1 in which the thermosetting resin and fabric fiber laminate is provided with one or more lubricant fillers.

6. A bridge bearing system according to claim 5 in which the lubricant filler comprises molybdenum disulphide, PTFE or graphite.

7. A bridge bearing system according to claim 1 in which a pair of contact surfaces are planar.

8. A bridge bearing system according to claim 1 in which a pair of contact surfaces are defined by complementary recessed and domed surfaces on the respective elements.

9. A bridge bearing system according to claim 1 which provides both a pair of planar contact surfaces and a pair of complimentary non-planar surfaces.

10. A bridge bearing system according to claim 1 in which the bearing system comprises an element with a dished contact surface, the dished surface being complimentary to a domed contact surface on an intermediate element, the intermediate element providing a planar contact surface complimentary to a contact surface on a further element.

11. A bridge bearing system according to claim 1 in which releasable fastenings for the first and/or second and/or further element are provided to facilitate installation and replacement

12. A bearing system according to claim 1 in which one or both of the elements are provided with one or more recesses in the contacting surface or surfaces, the recesses providing a lubricating material.

13. A bridge bearing system according to claim 12 in which the recesses are provided at a density of more than 2% of the contact surface.

14. A bridge bearing system according to claim 12 in which the recesses are between 1 mm and 5 mm in diameter and/or between 1 mm and 5 mm in depth.

15. A bridge bearing system according to claim 1 in which both of the elements are provided with a contact surface formed from a fiber reinforced material, in a bridge structure.

16. A bridge bearing system according to claim 15 in which the bearing surfaces are provided at one or more of a bridge deck to support strut contacts and/or a support structure to foundation contact and/or an expansion joint.

17. A bridge bearing surface comprising a first element and a second element in sliding contact with one another and wherein one of the elements, including the contact surface of that element, is formed from a fiber reinforced material.

18. A bridge bearing surface according to claim 17 wherein the first and second elements are formed from fiber reinforced material.

19. A method of producing a bridge bearing surface comprising the steps of:
a) providing a fiber reinforcing;
b) substantially enclosing and/or impregnating the fiber with a material; and
c) producing a bridge bearing surface of the desired configuration from the fiber reinforced material.

20. A method according to claim 19 in which the bearing surface is planar or non-planar, such as a dished bearing surface.

21. A method according to claim 19 in which a plurality of elements with one or more complimentary bearing surfaces are formed.

22. A method according to claim 19 in which a plurality of bearing/contact surfaces are formed on a single element.

23. A method according to claim 19 which includes the steps of providing recesses in the bearing surface and introducing a lubricant to the recess.

24. A method according to claim 23 which comprises filling the recesses beyond the bearing surface followed by a machining stage to remove excess lubricant material back to the bearing surface.

25. A method according to claim 23 in which the recesses are filled with the lubricant comprising a PTFE suspension in binders.

26. A method according to claim 25 in which loadings of PTFE of between 75% and 95% are provided.
